(19) United States
(12) Patent Application Publication
(10) Pub. No.: US 2010/0235730 A1
(43) Pub. Date: Sep. 16, 2010

(54) CONSUME-FIRST MODE TEXT INSERTION

(75) Inventors: Dustin Campbell, Bellevue, WA (US); Karen Liu, Bellevue, WA (US); Kevin Pilch-Bisson, Snohomish, WA (US); Thomas Peter Meschter, Renton, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/403,483

(22) Filed: Mar. 13, 2009

(51) Int. Cl. G06F 17/27

(52) U.S. Cl. 715/256; 714/37

(57) ABSTRACT

A consume-first mode for an editor is automatically entered if one or more predefined heuristic conditions are met. Some examples of heuristic conditions include conditions indicating that a user will be entering computer program source code during test-driven development, user action to undo autocompletion, and expected entry of a dynamically typed item identifier. In addition to heuristic consume-first mode, some editors recognize an explicit command to enter or exit the consume-first mode. A list of completion suggestions may be displayed in the consume-first mode, but autocompletion is turned off. An identifier may also be preemptively included on a suggested completions list for use before a user has entered that identifier using the editor.

### BACKGROUND

To write prose in a natural language such as English, an author must make many choices, at different levels of abstraction. At the most abstract level, the author selects ideas and places them in an order. At a less abstract level, the author selects words to express the ideas, and places the words in order within sentences, paragraphs, and chapters, for example. At a very specific level, the author selects characters and places them in order to spell the chosen words. Creativity and distinctiveness are generally encouraged in the selection and ordering of ideas and of words, but not in the selection and ordering of characters to spell words.

By contrast, to write computer source code in a programming language, creativity and distinctiveness may be helpful—or even essential—at every level of abstraction. In C#, Basic, and most (if not all) of the many other programming languages available, authors of computer programs make selections and place their selections in order, at every level from the most abstract to the most specific. In particular, authors of computer programs often create new words by creating new identifiers for variables, classes, types, objects, files, and other items which are defined or manipulated using software.

Some programming environments contain tools to help programmers keep track of the identifiers that have been defined thus far in a given file, or in a given program. For example, some source code text editors provide an autocompletion service, by predicting what word or phrase a user is typing before the user has finished typing it, and then automatically completing for the user the typing of that word or phrase. A list of suggested completions may also be displayed, allowing the user to choose from the list to complete the desired word or phrase without typing the entire word or phrase. In addition to source code editors, autocompletion is used by some editors in other environments, such as in web browsers, email programs, and database query tools.

### SUMMARY

Although autocompletion is often helpful, sometimes an autocompletion is inconvenient because a user accidentally selects an existing identifier when a new one is desired, or the editor completes a word or phrase automatically from a list of previously entered words and phrases but the user actually wanted to create a new word or phrase. When autocompletion enters a word or phrase that was not desired, the user must remove the undesired completion and then enter the desired word or phrase, thereby expending more effort than would have been needed to enter the desired word or phrase without the autocompletion feature.

Some embodiments described herein provide a heuristic consume-first mode for an editor. User input is automatically compared to a set of predefined heuristic condition(s) for placing the editor in the consume-first mode. If the embodiment determines that one or more of the condition(s) have been met, then the editor is automatically placed in the consume-first mode. A list of completion suggestions may be displayed in the consume-first mode, but autocompletion is turned off. Some examples of heuristic condition(s) for placing the editor in the consume-first mode include (i) indications that a user will be entering computer program source code during test-driven development, (ii) user action to undo autocompletion, and/or (iii) code analysis indicating that an item being entered will be dynamically typed.

In addition to heuristic consume-first mode, some embodiments recognize an explicit command to remove the editor from the consume-first mode, and/or an explicit command to place the editor in the consume-first mode. In addition to the consume-first mode, some editors also have a completion-assistance mode, such as an autocompletion feature with or without user selection from a list of suggested completions. Some embodiments preemptively include an identifier on a suggested completions list for use in the completion-assistance mode, before a user has entered that identifier using the editor.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, at least one editor, and other items in an operating environment which may be present on multiple network nodes, and also illustrating configured storage medium embodiments;

FIG. 2 is a block diagram illustrating an editor with a heuristic consume-first mode in an example architecture; and

FIG. 3 is a flow chart illustrating steps of some method and configured storage medium embodiments.

### DETAILED DESCRIPTION

### Overview

Autocompletion is a feature of various editors, such as editors used for source code creation, query creation, web browser form fill-in, and editors for other purposes. Source code editing is used as a convenient example herein, but it will be appreciated that embodiments are not limited to source code editors, just as autocompletion is not limited to source code editors.

One familiar autocompletion tool is the Microsoft® IntelliSense® utility (marks of Microsoft Corporation). During editing of computer program source code, an IntelliSense® suggestion list helps developers by providing easy access to identifiers that denote existing types and members. However, if a user prefers a “consume-first” style of development in which types and members are used in program code before they are declared, IntelliSense® activity can be inconvenient.

For example, suppose the user attempts to type program code which uses a type “Stack” before that type is declared. In this scenario, the user begins typing the identifier, “Stack,” and an IntelliSense® statement completion interface appears with a list of suggestions. However, because “Stack” is not yet declared, IntelliSense® code selects the closest match, “StackOverflowException.” When the user presses the space key, the IntelliSense® code inserts “StackOverflowException” in the text being edited, which is not what the user wanted.

Some embodiments herein provide a “consume-first” mode for IntelliSense® code and other autocompletion utilities. Consume-first is an editor insertion mode in which automated word or phrase completion does not penalize a user for typing text that does not appear in the autocompletion suggestion list. Consume-first insertion mode can be entered/exited explicitly, via a keyboard shortcut, for example, or implicitly, by heuristics code if the user performs an action that indicates that they are/aren't writing in a consume-first style. By toggling into consume-first mode, for example, users are able to type identifiers which are not yet declared, without inconvenient autocompletion activity. Unlike an approach which includes all recently used identifiers in the suggestion list, with the consume-first mode a user is not hindered by autocompletion when typing an identifier for the first time.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Editor” means any software and/or special-purpose hardware which accepts user textual input. Editors need not be stand-alone programs; a web browser form-filling assistant, for example, is an editor as that term is used herein. Some other examples of editors are found in email programs, search engine interfaces, database query engine interfaces, word processors, XML editors, and source code editors. Although examples are given in English herein, editors may accept text in one or more natural languages and/or text in one or more programming languages or other highly structured languages; editors are not necessarily limited to English input.

Throughout this document, use of the optional plural “(s)” means that one or more of the indicated feature is present. For example, “condition(s)” means “one or more conditions” or equivalently “at least one condition”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

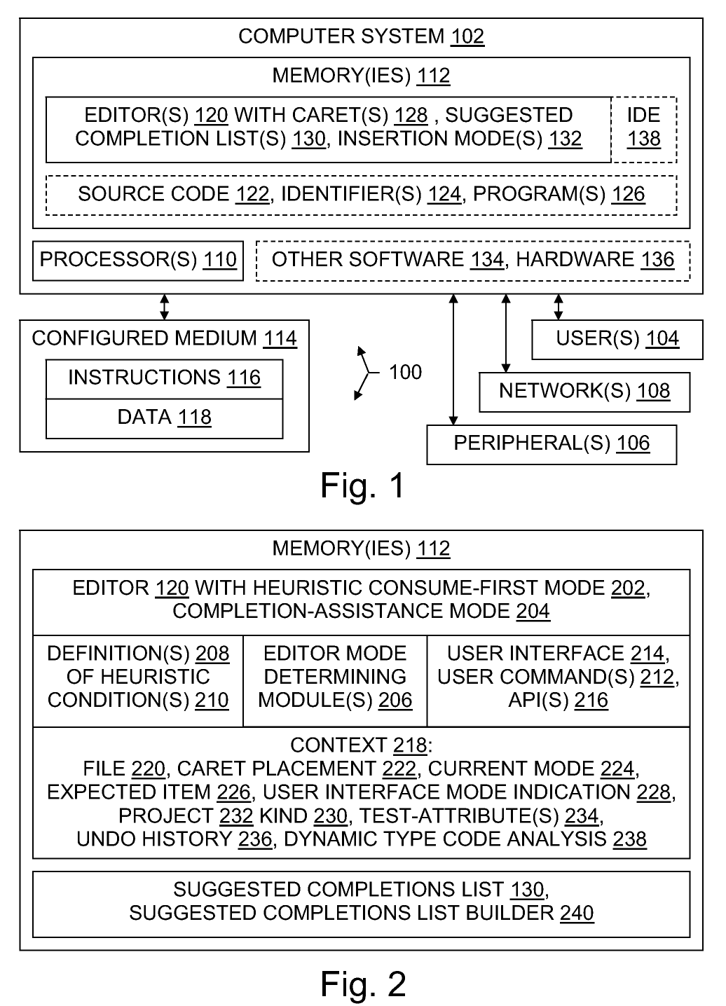

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more memories 112. The memories 112 may be volatile, non-volatile, fixed in place, removable, magnetic, optical, and/or of other types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a memory 112. Other examples of memory 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the memory 112/medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by as discussed herein, e.g., by mode-dependent completion or lack thereof, mode selection, mode indication, heuristics definition, code analysis, suggested completions list display, and/or other operations.

One or more editors 120 in the system 102 are available to user(s) 104 to enter text. For instance, source code 122 containing identifiers 124 and other programming language text may be entered, to be transformed by the system 102 into executable program(s) 126. Other types of editor 120 may be present, instead of source code editor(s) or in addition to source code editor(s). Each editor 120 will typically have at least one caret 128, often indicated by a vertical line cursor or other graphical device, which specifies the current position for insertion/deletion of text being edited. Some editors will have a suggestion completion list 130 which is generated based on previously entered identifiers 124, and which offers autocompletion options to a user. Editors 120 will typically have at least one insertion mode 132, and may have multiple insertion modes apart from any consume-first mode. For instance, an editor may have an “insert” mode in which typed text is inserted at the caret position without altering existing text, a “replace” mode in which typed text overwrites existing text, and/or a “command” mode in which typed text is interpreted as commands (save to disk, open file, etc.).

Memories 112 may be of different physical types. An editor 120, other software 134, and other items shown in the Figures may reside partially or entirely within one or more memories 112, thereby configuring those memories. An operating environment may also include other hardware 136, such as buses, power supplies, and accelerators, for instance.

A given operating environment 100 may include an Integrated Development Environment (IDE) 138 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development per se that use source code editors and/or other kinds of editor(s).

Several items are shown in outline form in FIG. 1 to indicate that they are not necessarily part of the illustrated operating environment, but may interoperate with items in the operating environment as discussed herein. Thus, an operating environment will not necessarily include source code 122 if the editor 120 of interest is not a source code editor. Suggested completion lists 130 are also optional, even though for convenient illustration they are shown in a solid form block with editor(s) 120.

Systems

With reference to FIGS. 1 through 3, some embodiments provide a computer system 102 with a logical processor 110 and a memory 112 configured by circuitry, firmware, and/or software to transform an editor 120 by heuristically entering the editor into and/or out of a consume-first mode as described herein.

For example, FIG. 2 illustrates an architecture which is suitable for use with some embodiments. An editor 120 has a consume-first mode 202 and a completion-assistance mode 204. In the completion-assistance mode 204, a completion assistant, such as an IntelliSense® utility or another autocompletion tool, extends user input based on previously provided input. A suggested completions list 130 may be displayed to the user by the completion assistant when the editor is in completion-assistance mode 204, with a suggestion automatically highlighted so the user can easily accept the suggestion (e.g., by pressing the space bar as a commit key) to have the suggestion entered in the text being edited.

In a consume-first mode 202, by contrast, as explained further herein, autocompletion is not performed. However, a suggested completions list 130 may nonetheless be displayed to the user in consume-first mode, e.g., to help the user remember what identifiers 124 have already been defined so the user does not inadvertently use an existing identifier when a new identifier is desired.

In some embodiments, the consume-first mode 202 is heuristic, in that it is automatically entered—without an explicit user mode-entry command—in response to conditions that define situations in which consume-first mode may be desired, or may at least be appreciated once provided. Mode determining module(s) 206 test the editor's context, and use definitions 208 of heuristic conditions 210 to determine what insertion mode the editor 120 should be in, changing the insertion mode automatically and/or in response to explicit user command(s) 212. The command(s) 212 may be received through a user interface 214 such as a Graphical User Interface, and/or received through a programmatic interface such as an API 216. The mode determining module(s) 206 may be integrated into the editor 120 and/or implemented separately, e.g., as plug-ins or scripts. The definitions 208 may be implemented in code instructions, switch statements, tables, or other mechanisms. Examples of heuristic conditions 210 are provided below.

The editor's context 218 for purposes of insertion mode control may include, for example, a set of file(s) 220 (if any) currently open for editing, the caret 128 placement 222 in the editor, the editor's current insertion mode 224 (e.g., consume-first mode or completion-assistance mode), the nature of an expected item 226 (e.g., previously entered identifier versus new identifier), a user interface insertion mode indication 228 (e.g., display of a blank box in consume-first mode versus display of a highlighted suggestion in completion-assistance mode), the kind 230 of project 232 being edited (e.g., test project versus update to existing production code), the proximity of any test-attributes 234 (e.g., [test-module], [test-class] in a source code editor), an undo history 236 (e.g., whether an autocompletion undo was performed most recently), and/or a result of dynamic type source code analysis 238 indicating whether a static-typed identifier or a dynamic-typed identifier is expected as input. A suggested completions list 130 created by a suggested completions list builder 240 (e.g., an IntelliSense® builder) may also be considered part of the editor's context.

Some embodiments provide a computer system 102 having a logical processor 110 and memory 112. An editor 120 configures the memory in operable communication with the logical processor. The editor has multiple insertion modes 132, which include a consume-first mode 202 and a completion-assistance mode 204. It will be understood that “a” logical processor means “at least one” logical processor, and that the insertion modes are not necessarily limited to the two modes listed here.

The system also includes definition(s) 208 of heuristic condition(s) 210 for placing the editor into (or out of) the consume-first mode. A given definition 208 may define one or more conditions 210. A given embodiment may include, for example, definition(s) 208 of one, two, three, or more of the following conditions 210 for placing the editor into consume-first mode: creation of a test project 232 is requested in an integrated development environment 138; a test-attribute 234 is entered at least a threshold number of times for a given file 220, the threshold being at least two; an editor caret 128 is placed at least a threshold number of times within a given set of files 220 in source code that is marked with a test-attribute 234, the threshold being at least two; an automatic extension of identifier 124 text entered while the editor is in the completion-assistance insertion mode 204 is undone (e.g., per the undo history 236) at least a threshold number of times, the threshold being at least two; an editor caret 128 is positioned at a location for which code analysis 238 indicates a user will be entering computer program source code for an identifier 124 to identify a dynamically typed item 226. Corresponding conditions 210 for exiting from consume-first mode are readily identified, e.g., closing a test project, positioning the editor caret outside the scope of any test-attribute, expecting entry of a statically-typed item, repeated acceptance of autocompletions, and so forth.

Some embodiments include an API 216 designed to command the editor 120 to move in and/or out of the consume-first mode. In some embodiments designed for a Microsoft® Visual Studio® integrated development environment, an API for the consume-first mode for IntelliSense® functionality is a standard command called “Edit.ToggleConsumeFirstCompletionMode.” There are existing APIs within the Visual Studio® IDE for executing commands directly. A user could execute the consume-first mode command to enable or disable consume-first mode via a third-party Visual Studio® add-in, for example, and/or bind the command to a new keyboard shortcut which differs from a default.

Some embodiments include a user interface indication 228 of the editor's current mode 224. For instance, embodiments which provide the user with a keyboard shortcut or another way to explicitly change the commit behavior of IntelliSense® code from completion-assistance mode to consume-first mode may offer user interface 214 feedback that indicates which mode is active. If an embodiment has only two modes (completion-assistance mode and consume-first mode), then a mode indication may be shown only when the editor 120 is in consume-first mode; completion-assistance mode would be a standard mode denoted by the absence of a user interface mode indication 228. User interface mode indications 228 might be manifest in one or more of the following ways, for example: a tooltip hint could display the name of the current mode; a colored outline could be drawn around the IntelliSense® window when in consume-first mode; the identifier text in the editor that is currently being typed might be displayed differently (e.g. highlighted with color or italicized). Other approaches could also be taken.

In some embodiments, the editor 120 is configured to have the consume-first mode off by default when the editor initializes. Consume-first mode may then be entered automatically by heuristics and/or explicitly by user command. In some embodiments, an integrated development environment containing the editor is configured to have the consume-first mode not persist between user sessions of the integrated development environment.

In some embodiments peripherals 106 such as human user I/O devices (screen, keyboard, mouse, tablet, microphone, speaker, motion sensor, etc.) will be present in operable communication with one or more processors 110 and memory 112. However, an embodiment may also be deeply embedded in a system, such that no human user 104 interacts directly with the embodiment. Software processes may be users 104.

In some embodiments, the system includes multiple computers connected by a network in a browser-based collaborative environment. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Methods

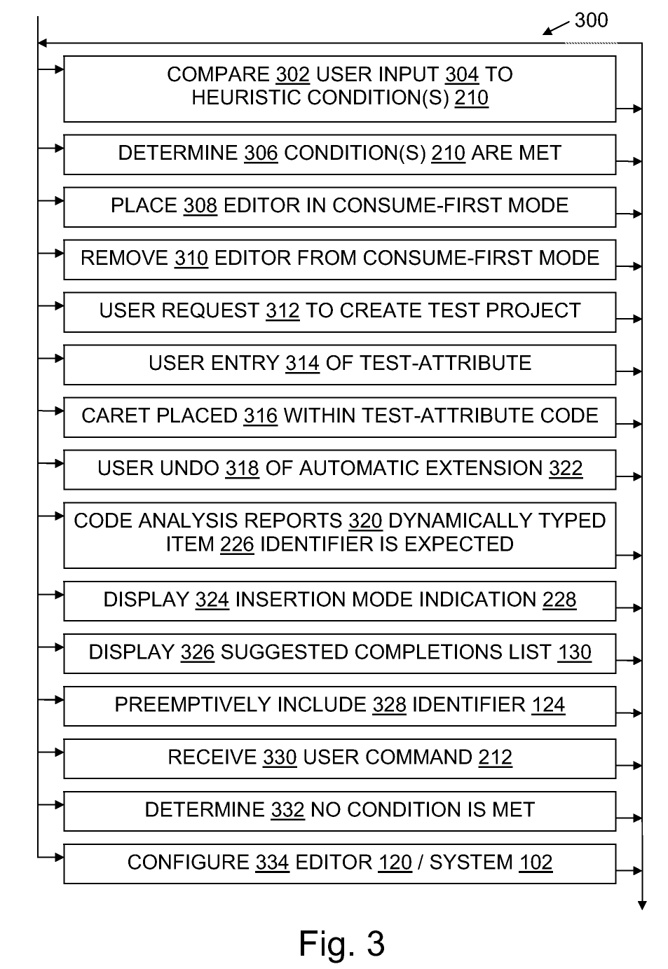

FIG. 3 illustrates some method embodiments in a flowchart 300. Methods shown in the Figures may be performed in some embodiments automatically, e.g., by an editor 120 under control of a script requiring little or no user input. Methods may also be performed in part automatically and in part manually unless otherwise indicated. In a given embodiment zero or more illustrated steps of a method may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During a comparing step 302, an embodiment compares user input 304 to heuristic conditions 210 to identify condition(s) which may be applicable. For example, user input in the form of user placement of an editor caret and user-provided source code text may be compared to conditions to identify as applicable a heuristic condition that would place the editor into consume-first mode if the user places the caret inside source code that is marked with a test-attribute. By contrast, a heuristic condition based on a request to create a test project would not be applicable to caret placement input. Step 302 may be accomplished using switch or case statements, or a rule-based mechanism such as those developed for expert systems, and/or other mechanism(s), for example.

During a determining step 306, an embodiment determines whether heuristic condition(s) are met. Some embodiments complete the determining step as soon as one heuristic condition 210 is met or all defined heuristic conditions have been checked, while other embodiments allow gathering of statistics on the various conditions 210 by completing the determining step only after checking all conditions 210. Step 306 may be accomplished by code in an editor mode determining module 206, for example. The term “module” is used broadly herein, to include tasks, libraries, routines, plug-ins, and other forms of executable code, which may vary according to the implementation chosen.

During a placing step 308, an editor 120 of an embodiment is placed in a consume-first mode. In the consume-first mode, autocompletion is turned off. A suggested completions list 130 may be displayed in some embodiments in consume-first mode; in other embodiments, no suggested completions list is displayed in consume-first mode. Consume-first mode is in contrast to completion-assistance mode, in which autocompletion is turned on. Step 308 may be accomplished by setting a global flag, by altering command flow, and/or by other mechanisms in an embodiment.

During a removing step 310, an editor 120 of an embodiment is removed from a consume-first mode, e.g., by being placed into completion-assistance mode. A result of removing step 310 is that autocompletion is turned on. Step 310 may be accomplished using mechanisms such as those used to accomplish step 308.

Steps 312-320 correspond to heuristic conditions 210 for placing an editor in a consume-first mode. Some embodiments adaptively learn when a user wishes to use a consume-first mode. For example, a heuristic with a threshold greater than a single occurrence of a specified condition might not trigger consume-first mode initially, but after a user has explicitly toggled into consume-first mode while the condition exists some specified number of times, this heuristic would be enabled.

During a step 312, an embodiment receives or otherwise notes a user request to create a test project. For example, some embodiments assume that creation of a Visual Studio® Test Project means that the user wishes to write tests using test-driven development. Test-driven development is a programming paradigm in which the user writes tests against APIs before the APIs are declared, that is, a form of consume-first development. Accordingly, such an embodiment in a Visual Studio® environment automatically activates a consume-first mode for the IntelliSense® utility while the user is editing code inside the Test Project.

During a step 314, an embodiment receives or otherwise notes a user entry of a test-attribute.

During a step 316, an embodiment receives or otherwise notes a user caret placement within test-attribute code. Test methods, for instance, may be located by virtue of an affixed test-attribute for methods:

[TestMethod]

public void TestCreateCustomer( )
{
}

During a step 318, an embodiment receives or otherwise notes a user request to undo an autocompletion; an autocompletion is also referred to herein as an “automatic extension” 322.

During a step 320, an embodiment receives or otherwise notes that a user is expected to enter an identifier 124 of a dynamically typed item 226, based on syntactic and/or semantic analysis 238 of the source code being edited.

During a mode displaying step 324, an embodiment displays an insertion mode indication in a user interface 214.

During a suggestions displaying step 326, an embodiment displays a suggested completions list 130 in a user interface 214, e.g., an IntelliSense® builder 240 list of identifiers or another list of the type used with autocompletion.

During a preemptive including step 328, an embodiment preemptively (that is, before a user has entered it) enters an identifier in a suggested completions list. Identifiers may be preemptively added in case the user wants to type them, in order to alleviate unintended autocompletion commits by a user of IntelliSense® code or another autocompletion utility. User testing may identify likely identifiers by revealing which identifiers are most often unintentionally entered by autocompletion.

One example of a good candidate for preemptive inclusion is the identifier T in Microsoft® Visual Studio® C# development environments. Some embodiments add T to the IntelliSense® list when the editor caret is in the position where the return type of a member or delegate would be declared. In such a situation, a user might want to use the generic type parameter T, even though that generic type parameter has not yet been declared.

As an illustration of a scenario for preemptive inclusion 328, suppose the user wishes to type a generic method which returns the most common generic type parameter, T. The expected code would look like the following:

public class MyClass
{
public T MyMethod<T>( ) { }
}

The user will begin by typing the keyword “public” followed by a space character. Next, the user types T:

public class MyClass
{
public T|
}

The caret is positioned immediately after the T. In a completion-assistance mode, the IntelliSense® Builder 240 displays a list of suggestions next to the caret, including, e.g., SystemException, ThreadStaticAttribute, TimeoutException, and other identifiers, with ThreadStaticAttribute highlighted. Unfortunately, when the space character is pressed to enter the space after the T, IntelliSense® code commits the currently selected item, ThreadStaticAttribute:

public class MyClass
{
public ThreadStaticAttribute |
}

A solution is to preemptively add “T” to the IntelliSense® list 130 in case the user wishes to type it. With “T” in the list, pressing space no longer inconveniences the user when an IntelliSense® list entry is committed.

During a command receiving step 330, an embodiment receives a user command through a user interface 214. In particular, some embodiments support user commands to explicitly (as opposed to heuristically) enter/exit consume-first mode.

During a determining step 332, an embodiment determines that no heuristic condition 210 is met. This may be accomplished by attempting a determining step 306 and checking all defined heuristic conditions 210 without finding any of the condition(s) satisfied.

During a configuring step 334, an embodiment is configured by setting initialization conditions, persistence conditions, and/or other parameters. Configuring an editor 120 that is part of a system 102 is one example of configuring a system 102. For example, an editor may be configured to start initially in completion-assistance mode rather than starting in consume-first mode, or vice versa. As another example, a system may be configured to maintain the insertion mode of an editor between user sessions, or to not maintain that mode.

The foregoing steps and their interrelationships are discussed in greater detail below, in connection with various embodiments. Other combinations of these steps are also possible, consistent with the teachings herein.

Some embodiments provide a method for controlling insertion modes, in an editor 120 having multiple insertion modes which include a completion-assistance mode and a consume-first mode. The method includes automatically comparing 302 user input to a set of predefined heuristic condition(s) 210 for placing the editor in the consume-first mode. The predefined heuristic condition(s) exclude an explicit user command to toggle the editor into the consume-first mode; some embodiments provide that command 212, but the present method is focused on heuristic entry into consume-first mode rather than being focused on explicit entry. The method automatically determines 306 (in at least one case) that predefined heuristic condition(s) for placing the editor in the consume-first mode have been met, and then automatically places 308 the editor in the consume-first mode. For instance, some embodiments use heuristics to automatically enter consume-first mode from a completion-assistance mode such as a standard mode in which IntelliSense® autocompletion is on.

Some methods further include removing 310 the editor from the consume-first mode in response to an explicit user command 212 to move the editor out of the consume-first mode. For instance, such methods are performed in a scenario in which the editor automatically enters consume-first mode and then the user explicitly exits consume-first mode to turn IntelliSense® or another autocompletion tool back on.

In some methods, the determining step 306 determines that predefined heuristic condition(s) 210 for placing the editor in the consume-first mode have been met because the user has requested 312 creation of a test project 232 in an integrated development environment 138, thereby indicating that the user will be entering computer program source code during test-driven development. For example, some embodiments automatically enter consume-first mode when a user creates a test project in a Visual Studio® environment.

In some methods, the determining step 306 determines that predefined heuristic condition(s) 210 for placing the editor in the consume-first mode have been met because the user has entered at least one test-attribute 234, thereby indicating that the user is entering computer program source code during test-driven development. For example, some embodiments automatically enter consume-first mode when user types a required number of attribute(s) such as [TestMethod], [TestClass]. The required number could be one or more in a given situation.

In some methods, the determining step 306 determines that predefined heuristic condition(s) 210 for placing the editor in the consume-first mode have been met because the user has placed 316 an editor caret at least once within source code that is marked with a test-attribute, thereby indicating that the user is entering computer program source code during test-driven development.

In some methods, the determining step 306 determines that predefined heuristic condition(s) 210 for placing the editor in the consume-first mode have been met because the following completion-undo 318 sequence has occurred at least once: the user has entered identifier text while the editor is in the completion-assistance insertion mode, the user has then caused extension of the identifier text into a complete identifier on a suggested completions list by entering an identifier termination character, and the user has then undone the automatic extension. For example, some embodiments automatically enter consume-first mode when a user undoes IntelliSense® identifier completion a required number of times, which may be one or more times depending on the embodiment. Some embodiments log the identifier entered by the user after the undo and treats that identifier as a candidate for preemptive inclusion 328.

In some methods, the determining step 306 determines that predefined heuristic condition(s) 210 for placing the editor in the consume-first mode have been met because an editor caret is positioned at a location for which code analysis 238 indicates that the user will be entering computer program source code for an identifier to identify a dynamically typed item. That is, a heuristic condition 210 may be based on the type of the expression for which a completion list is being displayed. Microsoft tools for the Visual Basic and C# 4.0 languages, for instance, contain a notion of a type that is “dynamically bound”. The compiler doesn't know at compile-time what members belong to a dynamically bound type; members are decided at runtime. An IDE 138 may use code analysis to determine that a given expression results in an instance of a dynamic type, and then automatically enter consume-first mode because any identifier is potentially valid in such a location. Consider, for example, the following C# 4.0 code:

```
class Program
{
  static void Main(string[ ] args)
  {
    dynamic d;
    d.Something
  }
}
```

When a user is typing the “.” in “d.Something”, the IDE may determine that “d” is of dynamic type and therefore automatically place 308 the editor in consume-first mode.

Some embodiments provide a method for automatically placing an editor 120 in a consume-first mode, the editor having multiple insertion modes which include a consume-first mode and a completion-assistance mode, with the method automatically determining 306 that at least one of the following heuristic condition(s) for placing the editor in the consume-first mode have been met: creation of a test project is requested 312 in an integrated development environment; a test-attribute 234 is entered; an editor caret is placed 316 within source code that is marked with a test-attribute; an automatic extension 322 of identifier text entered while the editor is in the completion-assistance insertion mode is undone; an editor caret is positioned at a location for which code analysis 238 indicates a user will be entering computer program source code for an identifier to identify a dynamically typed item. Then the method automatically places the editor in the consume-first mode.

Some methods further include displaying 324 a user interface indication that the editor is in the consume-first mode. Some methods further include displaying 326 a suggested completions list in the consume-first mode. Some methods further preemptively include 328 an identifier on a suggested completions list for use in the completion-assistance insertion mode before a user has entered that identifier in a given file using the editor, e.g., by adding a generic type parameter to a return types suggestion list 130 before a user defines that type in the program source being edited.

Some methods further include subsequently removing 310 the editor from the consume-first mode in response to an explicit user command to move the editor out of the consume-first mode. Some include subsequently removing 310 the editor from the consume-first mode in response to determining that none of the heuristic condition(s) 210 are met.

Some embodiments provide an ability to detect when the user is writing in a consume-first style and automatically toggle the editor into a consume-first mode. Reference is made from time to time herein to “a” consume-first mode”, instead of “the” consume-first mode, as a reminder that embodiments may differ in the specifics of their respective consume-first mode behaviors. For example, some embodiments display a suggested completions list 130 in their consume-first mode while others do not; some differ in their use of mode indication(s) 228; some embodiments are triggered by different heuristic condition(s) than other embodiments, and so on.

In some embodiments, when the user wishes to write in a consume-first style, they can press a shortcut key to toggle into consume-first mode. When consume-first mode is active in some embodiments adapted for use with Visual Studio® or another Microsoft IDE, an IntelliSense® Builder is activated at the top of the IntelliSense® suggestion list.

The IntelliSense® Builder is an existing feature of the IntelliSense® suggestion list. In some systems, the IntelliSense® Builder was only activated in known ambiguous cases; that is, known scenarios where the user might want to type a new identifier or choose something from the IntelliSense® suggestion list. In some embodiments described herein, consume-first mode 202 (whether entered heuristically and/or by explicit command) activates an IntelliSense® Builder whenever the suggestion list appears, not just in ambiguous cases.

By toggling into consume-first mode, the user is able to type new identifiers without inconvenient autocompletion. Solutions which attempt to include any identifiers that are not yet declared in the suggestion list may help, but they do not necessarily allow the user to type a new identifier for the first time.

In some embodiments, entering consume-first mode doesn't turn the completion list off. The list 130 is still displayed, which gives the user information about pre-existing elements, and allows the user to select one explicitly. The difference between consume-first mode and regular (completion-assistance) mode in some embodiments is that while the editor is in consume-first mode, even though the list 130 is displayed, the editor does not autocomplete user-entered text based on commit keys such as period, comma, space, and so on.

Configured Media

Some embodiments include a configured computer-readable storage medium 114, which is an example of a memory 112. Memory 112 may include disks (magnetic, optical, or otherwise), RAM, EEPROMS or other ROMS, and/or other configurable memory. The storage medium which is configured may be in particular a removable storage medium 114 such as a CD, DVD, or flash memory. A general-purpose memory 112, which may be removable or not, and may be volatile or not, can be configured into an embodiment using items such as definitions 208 of heuristic conditions 210, editor mode determining modules 206, APIs 216, mode indications 228, and so forth, in the form of data 118 and instructions 116, read from a removable medium 114 and/or another source such as a network connection, to form a configured medium. The configured memory 112 is capable of causing a computer system to perform method steps for transforming source code and other edited text, and the user's editing experience, through use of a heuristic consume-first mode as disclosed herein. FIGS. 1 through 3 thus help illustrate configured storage media embodiments and method embodiments, as well as system and method embodiments. In particular, any of the method steps illustrated in FIG. 3, or otherwise taught herein, may be used to help configure a storage medium to form a configured medium embodiment.

### ADDITIONAL EXAMPLES

One may observe that there are scenarios in C# and Visual Basic® coding where IntelliSense® statement completion impedes users from typing their intended code in the editor. Statement completion was originally designed with the expectation that the user would only use API and other identifiers that already exist, namely, identifiers that have already been bound or otherwise declared in the program that is being edited. However, in some situations the user types an identifier which does not exist in the statement completion list and presses a key that inadvertently causes the statement window to commit the currently highlighted entry, replacing the typed identifier. This inconvenience will become more pronounced as users make greater use of development environment features that support a “consume-first” style of writing code. In this writing style, the user writes code that consumes APIs before the APIs are declared. Since the APIs don't yet exist, statement completion would often commit unintentionally, replacing the code that the user typed with something else, which inconveniences the writer.

Embodiments described herein provide an alternative model for IntelliSense® statement completion behavior, to alleviate scenarios where IntelliSense® autocompletion is undesirable. In this context, “Insistent IntelliSense®” refers to a scenario in which IntelliSense® statement completion commits and inserts unintended text into the editor; “IntelliSense® Builder” refers to a field added to the top of the statement completion list which dynamically updates with the identifier that the user is currently typing in the editor; and “Commit Key” refers to a keystroke that causes statement completion to insert the currently selected into the text editor, such as <SPACE>, ‘.’ (period) or ‘(’ (open parenthesis).

As an illustrative scenario involving test-driven development, suppose Pat works for an agile start-up and has been assigned a new project, an order tracking system. Because Pat practices test-driven development, Pat begins by creating a new test file containing a test fixture class called CustomerTests. Pat's first test case in this fixture will instantiate and validate a Customer class, which has not yet been declared. First, Pat needs to declare a variable of type Customer like so:

C#:
Customer c = new Customer( );
VB:
Dim c As Customer = New Customer( )

Upon Pat typing the first character of Customer, the statement completion list appears. As Pat continues typing, the statement completion list is filtered to include only the items that are prefixed by the characters Pat has typed so far. When Pat finishes typing Customer, Pat notices that Customer is not included in the statement completion list and that CustomerTests is in fact the selected item. Pat realizes that the consume-first mode for statement completion is off. Pat presses Ctrl+Shift+J and the statement completion list is transformed to have an IntelliSense® Builder field located at the top of the list. Pat now confidently presses <SPACE>, knowing that autocompletion from the statement completion list will not get in the way in consume-first mode when undeclared identifiers are typed. Next, Pat types “new” to initialize the variable with a new Customer instance. Upon pressing space, the statement completion list appears. Pat again starts typing Customer and notices that the identifier is now included in the list, even though it is undeclared. Pat presses the down-arrow key until Customer is selected in the statement completion list 130 and presses the open parenthesis key to commit statement completion. In some alternate scenarios, consume-first mode is entered heuristically, e.g., in response to Pat typing “[TestMethod]” or requesting creation of a test project in the IDE 138.

As an illustrative scenario involving declaration of generics, suppose Sam is a professional developer who works primarily on libraries. As such, Sam regularly declares generic methods. Today Sam is tasked with implementing a generic function that will generate an array of T given a length and a delegate that will create each element of the array. Sam begins by declaring the delegate type:

public delegate T CreateItem<T> (int index);

To declare the delegate type, Sam first types public delegate. Upon pressing <SPACE>, the statement completion list 130 appears. Next, Sam types T. Because the statement completion list already includes an entry for a type parameter T as a helper for declaring generic return types, Sam can safely press <SPACE> and finish declaring the delegate type. Next, Sam begins declaring the generic function by first typing public T. Again, T appears in the statement completion list, so Sam can press [and continue declaring the function:

public T[ ] Create(int length, CreateItem<T> itemCreator)

More generally, some embodiments described herein allow a user to type an identifier that does not exist in a statement completion list. Some embodiments disable autocompletion for one or more identifier termination keys to ensure that statement completion does not commit unintentionally. Some embodiments provide a keyboard shortcut to quickly switch between the current statement completion behavior (completion-assistance mode) and alternative behavior (consume-first mode). Some embodiments use the alternative statement completion behavior in targeted Insistent IntelliSense® cases, even if the consume-first mode isn't explicitly turned on. Some embodiments provide user interface mode indication(s) 228 to notify users which mode of statement completion behavior is active. Some embodiments preemptively include 328 unbound symbols in IntelliSense® data to better support the consume-first style of development. Some embodiments improve the post-statement completion undo behavior of Visual Basic® tools to match C# tool behavior. Some embodiments display the identifier 124, as it is typed, sorted within the statement completion list 130.

In some embodiments, one or more of the following modifications are made to IntelliSense® statement completion. An additional user interface element, termed the IntelliSense® Builder, is provided for the statement completion list 130. Users are allowed to explicitly toggle between standard completion list behavior (completion-assistance mode) and consume-first mode. The IntelliSense® Builder is used, even in standard (completion-assistance) mode, to address cases of Insistent IntelliSense® behavior. A generic type parameter named T is preemptively included in statement completion for C# return types. Undo is improved for post-statement completion in Visual Basic® tools, to match C# tools. Unbound types are preemptively included in statement completion after the new keyword in both C# and Visual Basic code.

The IntelliSense® Builder appears as a special field at the top of the statement completion list 130 in some embodiments, possibly spanning the entire width of the window client. As the user types an identifier into the editor with the statement completion list shown, the Builder field is dynamically updated with the identifier. When guidance for the user may be helpful, the Builder field can contain placeholder text such as “<new field>”. However, as soon as a character is typed, or if the statement completion list is displayed due to a character being typed, the placeholder text in the Builder field is replaced with the identifier that the user is typing into the editor.

When the IntelliSense® Builder is present, there are two ways in which the currently selected item in the statement completion can be represented. When the IntelliSense® Builder is active, the currently selected item in the statement completion list receives a focus rectangle. If the statement completion list becomes active, the currently selected item is highlighted. If the IntelliSense® Builder field itself is selected, a tooltip is displayed describing the purpose of the field.

With regard to statement completion list filtering, in some embodiments if the identifier text in the editor only consists of one character, the statement completion list will display all possible items. However, if the identifier text contains two or more characters, the statement completion list will only display the items which match the identifier text. In some embodiments, the matching algorithm used will perform prefix, substring and camel-cased matches.

When the user types a valid identifier character, in some embodiments if there are no items in the statement completion list that match the identifier text, the statement completion list is dismissed. Otherwise, the IntelliSense® Builder field will be updated with the new identifier text, and the current selection in the statement completion list will move to the first item that matches the identifier text. If the identifier text is two or more characters in length, the statement completion list is filtered to include only those items that match the identifier text. The IntelliSense® Builder field is also made active if it wasn't previously.

When the user presses backspace in some embodiments, if backspace deletes the last identifier character, the statement completion list is dismissed. Otherwise, the IntelliSense® Builder field will be updated with the new identifier text, and the current selection in the statement completion list will move to the first item that matches the identifier text. If the identifier text is two or more characters in length, then for C# code the statement completion list is filtered to include only those items that match the identifier text; for Visual Basic code the statement completion list is no longer filtered against the identifier text. If the user types backspace they likely have made a mistake and should be presented with the full list. Filtering will be enabled again when the user types a valid identifier character. The IntelliSense® Builder field is made active if it wasn't previously.

When the user presses the up arrow key in some embodiments, if the IntelliSense® Builder field is active, the statement completion list will become active, highlighting the currently selected item. If the statement completion list is active, and the currently selected item is not the first item in the list, the selection is moved up one item. If the statement completion list is active, and the currently selected item is the first item in the list, the IntelliSense® Builder field itself will be highlighted.

When the user presses the down arrow key in some embodiments, if the IntelliSense® builder field is active, the statement completion list will become active, highlighting the currently selected item. If the statement completion list is active, and the currently selected item is not the last item in the list, the selection is moved down one item. If the statement completion list is active, and the currently selected item is the last item in the list, the selection does not change.

When the user presses tab as a commit key in some embodiments, the statement completion list is committed and the currently selected item is inserted into the text editor.

When the user presses a commit key other than tab in some embodiments, if the IntelliSense® Builder is active, the statement completion is dismissed and the selected item is not inserted. If the statement completion list is active, statement completion is committed and the currently selected item is inserted into the text editor (standard behavior).

When the user presses Esc in some embodiments, the statement completion list is dismissed and the selected item is not inserted.

When the user types any other character or presses any other key in some embodiments, the statement completion list is dismissed and the selected item is not inserted.

It will be appreciated that the foregoing detailed example of user interactions is merely illustrative. Different embodiments may use different keys, may respond differently to the same keys, and may otherwise depart from the foregoing detailed example.

In some embodiments, consume-first mode has one or more of the following characteristics. When the editor is in consume-first mode, the IntelliSense® Builder is active throughout the IntelliSense® experience. The consume-first mode is off by default. The consume-first mode is toggled via an API command, Edit.ToggleConsumeFirstMode, which is bound to Ctrl+Shift+J. The consume-first mode is not persistent between Visual Studio® sessions. If consume-first mode is enabled and the statement completion list is displayed due to a character being typed in the editor, the IntelliSense® Builder will be used. If the statement completion list is displayed due to the user pressing Ctrl+Space (Edit.CompleteWord) or Ctrl+J (Edit.ListMembers), the IntelliSense® Builder will not be used, regardless of whether consume-first mode is active. If consume-first mode is toggled while the statement completion list is visible, the statement completion list will be updated in place to include the IntelliSense® Builder (if consume-first mode is being enabled), or remove it (if consume-first mode is being disabled).

In some embodiments, a standard mode is the behavior in effect when consume-first mode is disabled. In some embodiments, standard mode has one or more of the following characteristics.

With regard to anonymous types, in some embodiments the IntelliSense® Builder will be used inside C# anonymous types in both standard and consume-first mode. The statement completion list will be displayed with the IntelliSense® Builder when <SPACE> or an identifier character is pressed in the following cases. First, after the opening curly brace of an anonymous type, e.g.,

var x=new {|
Second, after a comma inside the body of an anonymous type:
var x=new {ID=1, |

With regard to lambda expressions, in some embodiments the IntelliSense® Builder will be used in locations where lambda expressions can be declared, in both standard and consume-first mode.

With regard to “using” statements and “Imports” statements, in some embodiments the IntelliSense® Builder will be used after the using (C#) or Imports (Visual Basic) keywords, in locations where namespaces can be imported. The statement completion list will be displayed with the IntelliSense® Builder when <SPACE> is pressed after the using (C#) or Imports (Visual Basic) keywords. The statement completion list will contain namespace identifiers and namespace aliases. The IntelliSense® Builder field will contain the initial text “<namespace alias>=”.

With regard to preemptively including identifiers, some embodiments include T for return types in C#. When the statement completion list is displayed in a location where a delegate or method return type can be declared, an additional T type parameter item will be inserted into the list 130. This may occur in the following locations, for example. At the class level:

```
public class C {
    |
  }
```

After the delegate keyword in a delegate type declaration:
delegate |
After an accessibility keyword at the class level:

```
public class C {
    private |
  }
```

Inside of the generic type parameter block when referencing a generic type in any of the above locations. For example:

```
public class C {
    private IEnumerable<|
  }
```

With regard to improved undo after statement completion, in some embodiments Visual Basic® tools will be modified to match existing C# tools. When statement completion is committed, undo will revert the editor back to the text that would have been inserted had statement completion not committed.

With regard to including unbound types after the “new” keyword, in some embodiments when the user types “new” followed by <SPACE>, the statement completion list will be displayed, and will include any unbound types in scope. Below are two examples:

```
public class C {
  private Foo bar = new|
  }
public class C {
    public void M {
      Foo bar = new|
    }
  }
```

In both of the above examples, the unbound type Foo would appear within the statement completion list.

### CONCLUSION

Although particular embodiments are expressly illustrated and described herein as methods, as configured media, or as systems, it will be appreciated that discussion of one type of embodiment also generally extends to other embodiment types. For instance, the descriptions of methods in connection with FIG. 3 also help describe configured media, and help describe the operation of systems and manufactures like those discussed in connection with other Figures. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A method for controlling insertion modes, in an editor having multiple insertion modes which include a completion-assistance mode and a consume-first mode, the method comprising the steps of:
automatically comparing user input to a set of predefined heuristic condition(s) for placing the editor in the consume-first mode, the predefined heuristic condition(s) excluding an explicit user command to toggle the editor into the consume-first mode;
automatically determining that predefined heuristic condition(s) for placing the editor in the consume-first mode have been met; and then
automatically placing the editor in the consume-first mode.

2. The method of claim 1, further comprising removing the editor from the consume-first mode in response to an explicit user command to move the editor out of the consume-first mode.

3. The method of claim 1, wherein the determining step determines that predefined heuristic condition(s) for placing the editor in the consume-first mode have been met because the user has requested creation of a test project in an integrated development environment, thereby indicating that the user will be entering computer program source code during test-driven development.

4. The method of claim 1, wherein the determining step determines that predefined heuristic condition(s) for placing the editor in the consume-first mode have been met because the user has entered at least one test-attribute, thereby indicating that the user is entering computer program source code during test-driven development.

5. The method of claim 1, wherein the determining step determines that predefined heuristic condition(s) for placing the editor in the consume-first mode have been met because the user has placed an editor caret at least once within source code that is marked with a test-attribute, thereby indicating that the user is entering computer program source code during test-driven development.

6. The method of claim 1, wherein the determining step determines that predefined heuristic condition(s) for placing the editor in the consume-first mode have been met because the following completion-undo sequence has occurred at least once: the user has entered identifier text while the editor is in the completion-assistance insertion mode, the user has then caused extension of the identifier text into a complete identifier on a suggested completions list by entering an identifier termination character, and the user has then undone the automatic extension.

7. The method of claim 1, wherein the determining step determines that predefined heuristic condition(s) for placing the editor in the consume-first mode have been met because an editor caret is positioned at a location for which code analysis indicates that the user will be entering computer program source code for an identifier to identify a dynamically typed item.

8. A computer-readable medium configured with data and instructions for performing a method for automatically placing an editor in a consume-first mode, the editor having multiple insertion modes which include the consume-first mode and a completion-assistance mode, the method comprising the steps of:
automatically determining that at least one of the following heuristic condition(s) for placing the editor in the consume-first mode have been met:
creation of a test project is requested in an integrated development environment;
a test-attribute is entered;
an editor caret is placed within source code that is marked with a test-attribute;
an automatic extension of identifier text entered while the editor is in the completion-assistance insertion mode is undone;
an editor caret is positioned at a location for which code analysis indicates a user will be entering computer program source code for an identifier to identify a dynamically typed item;
and then
automatically placing the editor in the consume-first mode.

9. The configured medium of claim 8, wherein the method further comprises displaying a user interface indication that the editor is in the consume-first mode.

10. The configured medium of claim 8, wherein the method further comprises displaying a suggested completions list in the consume-first mode.

11. The configured medium of claim 8, wherein the method further comprises preemptively including an identifier on a suggested completions list for use in the completion-assistance insertion mode before a user has entered that identifier in a given file using the editor.

12. The configured medium of claim 8, wherein the determining step determines that at least two of the heuristic condition(s) for placing the editor in the consume-first mode have been met.

13. The configured medium of claim 8, wherein the method further comprises subsequently removing the editor from the consume-first mode in response to an explicit user command to move the editor out of the consume-first mode.

14. The configured medium of claim 8, wherein the method further comprises subsequently removing the editor from the consume-first mode in response to determining that none of the heuristic condition(s) are met.

15. A computer system comprising:
a logical processor;
an editor configuring memory in operable communication with the logical processor, the editor having multiple insertion modes which include a consume-first mode and a completion-assistance mode; and
definition(s) of heuristic condition(s) for placing the editor in the consume-first mode.

16. The system of claim 15, wherein the definition(s) of heuristic condition(s) for placing the editor in the consume-first mode comprise definition(s) of at least three of the following conditions:
creation of a test project is requested in an integrated development environment;
a test-attribute is entered at least a threshold number of times for a given file, the threshold being at least two;
an editor caret is placed at least a threshold number of times within a given set of files in source code that is marked with a test-attribute, the threshold being at least two;
an automatic extension of identifier text entered while the editor is in the completion-assistance insertion mode is undone at least a threshold number of times, the threshold being at least two;
an editor caret is positioned at a location for which code analysis indicates a user will be entering computer program source code for an identifier to identify a dynamically typed item.

17. The system of claim 15, further comprising an API configuring the memory and designed to command the editor to move in and/or out of the consume-first mode.

18. The system of claim 15, further comprising a user interface indication of the editor's current mode.

19. The system of claim 15, wherein the editor is configured to have the consume-first mode off by default.

20. The system of claim 15, further comprising an integrated development environment in which the editor is embedded, and wherein the system is configured to have the consume-first mode not persist between user sessions of the integrated development environment.
